(19) United States
(12) Patent Application Publication
(10) Pub. No.: US 2010/0109201 A1
(43) Pub. Date: May 6, 2010

(54) Nano-Imprint Lithography Template with Ordered Pore Structure

(75) Inventors: Edward Brian Fletcher, Austin, TX (US); Frank Y. Xu, Round Rock, TX (US); Weijun Liu, Cedar Park, TX (US); Marlon Menezes, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/609,808

(22) Filed: Oct. 30, 2009

Related U.S. Application Data
(60) Provisional application No. 61/110,045, filed on Oct. 31, 2008.

(51) Int. Cl. B29C 41/42; B32B 3/26; B32B 5/00; B44C 1/22

(52) U.S. Cl. 264/334; 428/304.4; 428/195.1; 216/11

(57) ABSTRACT

A nano-imprint lithography template includes a non-porous base layer, a cap layer, and a porous layer between the base layer and the cap layer. The porous layer defines a multiplicity of pores and has an ordered pore structure. The cap layer is permeable to helium, and the pores in the porous layer are configured to accept gas passing through the cap layer during an imprint lithography process. The porous layer provides high porosity with a Young's modulus and hardness that are advantageous for imprint lithography processes.

### CROSS-REFERENCE TO RELATED APPLICATIONS

This application claims the benefit under 35 U.S.C. §119(e)(1) of U.S. Provisional Application Ser. No. 61/110,045, filed Oct. 31, 2008; which is incorporated by reference herein in its entirety.

### TECHNICAL FIELD

The present invention relates to nano-imprint lithography templates with an ordered pore structure in at least a portion of the template.

### BACKGROUND

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Application Publication No. 2004/0065976, U.S. Patent Application Publication No. 2004/0065252, and U.S. Pat. No. 6,936,194, all of which are hereby incorporated by reference herein.

An imprint lithography technique disclosed in each of the aforementioned U.S. patent application publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and the formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### SUMMARY

A nano-imprint lithography template includes a non-porous base layer, a cap layer, and a porous layer between the base layer and the cap layer. The porous layer defines a multiplicity of pores and has an ordered pore structure. The cap layer is permeable to helium, and the pores in the porous layer are configured to accept gas passing through the cap layer during an imprint lithography process. The porous layer provides high porosity with a Young's modulus and hardness that are advantageous for imprint lithography processes.

### BRIEF DESCRIPTION OF THE DRAWINGS

FIG. 1 illustrates a simplified side view of a lithographic system.

FIG. 2 illustrates a simplified side view of the substrate shown in FIG. 1 having a patterned layer positioned thereon.

FIG. 3 illustrates a side view of a gas pocket formed between a substrate and an imprint lithography template.

FIG. 4 illustrates a template with a porous layer having an ordered pore structure.

FIG. 5 illustrates a porous template with a sealed porous layer.

FIGS. 6A and 6B show scanning electron microscope images of a zeolite film on a silica substrate.

FIG. 7 illustrates placement of a template in an autoclave in a process to grow a zeolite layer on the template.

FIG. 8 shows a scanning electron microscope image of scattered zeolite seed crystals on a fused silica surface.

FIG. 9 shows a scanning electron microscope image of a continous layer of b-oriented crystals on a CrO film.

FIG. 10 shows a scanning electron microscope image of zeolite layer on a stainless steel substrate.

FIG. 11 shows a scanning electron microscope image of zeolite layer on a CrO surface.

### DETAILED DESCRIPTION

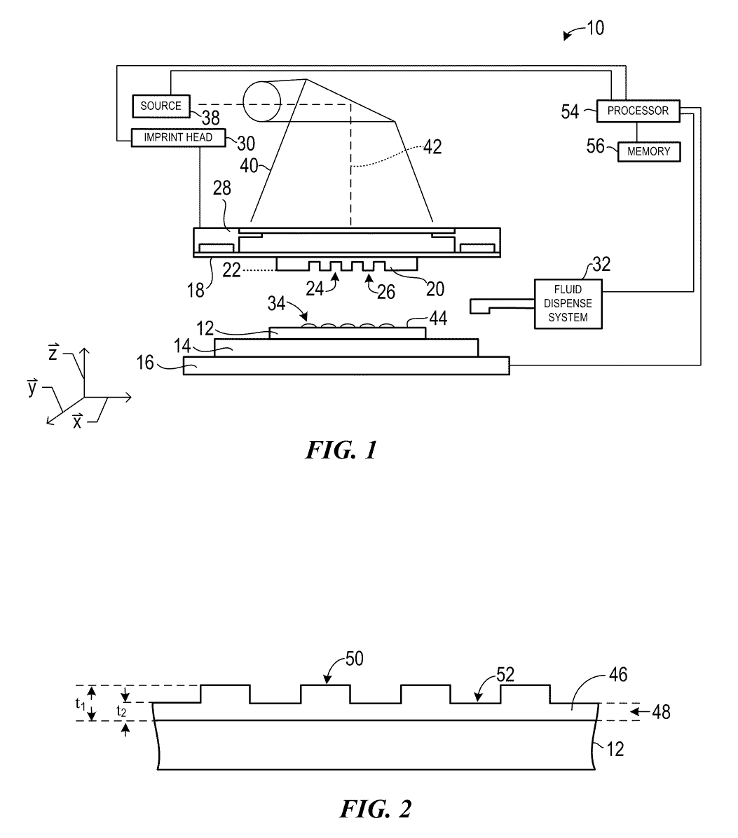

Referring to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer as described in U.S. Pat. No. 7,157,036 and U.S. Patent Application Publication No. 2005/0187339, all of which are hereby incorporated by reference herein.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer. 48 and a plurality of features shown as protrusions 50 and recessions 52, with protrusions 50 having a thickness t₁ and residual layer 48 having a thickness t₂.

The above-described system and process may be further implemented in imprint lithography processes and systems referred to in U.S. Pat. No. 6,932,934, U.S. Patent Application Publication No. 2004/0124566, U.S. Patent Application Publication No. 2004/0188381, and U.S. Patent Application Publication No. 2004/0211754, each of which is hereby incorporated by reference herein.

In nano-imprint processes in which polymerizable material is applied to a substrate by drop dispense or spin coating methods, gases may be trapped proximate recesses in the template after the template contacts the polymerizable material. In nano-imprint processes in which polymerizable material is applied to a substrate by drop dispense methods, gases may also be trapped between drops of polymerizable material or imprint resist dispensed on a substrate (e.g., on an imprinting stack). That is, gases may be trapped in interstitial regions between drops as the drops spread.

Gas escape and dissolution rates may limit the rate at which the polymerizable material is able to form a continuous layer on the substrate or the rate at which the polymerizable material is able to fill template features after the template contacts the polymerizable material, thereby limiting throughput in nano-imprint processes. For example, a substrate or a template may be substantially impermeable to a gas trapped between the substrate and the template. In some cases, a polymeric layer adhered to the substrate or the template may become saturated with gas, such that gas between the imprinting stack and the template is substantially unable to enter the saturated polymeric layer, and remains trapped between the template and the substrate. Gas that remains trapped between the template and the substrate may cause filling defects in the patterned layer.

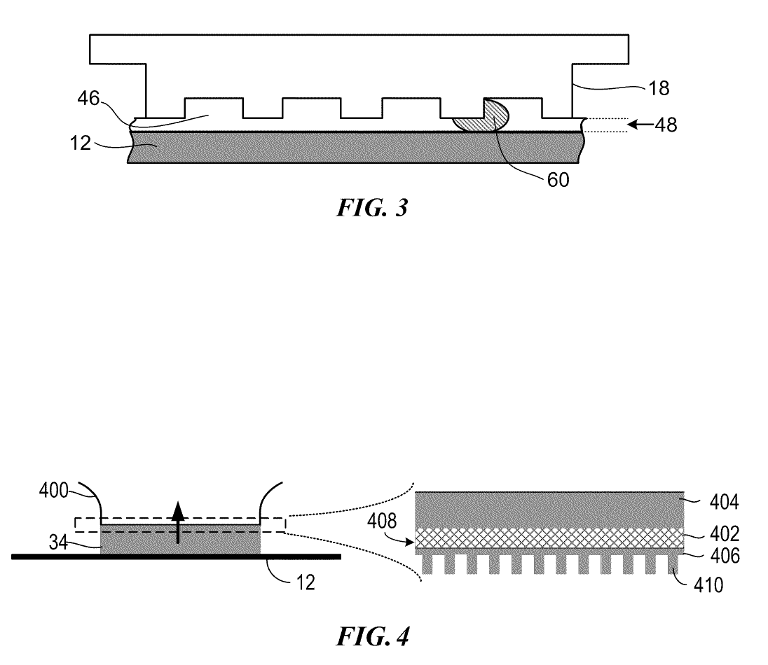

FIG. 3 illustrates gas (or gas pocket) 60 in patterned layer 46 between substrate 12 and template 18. The gas 60 may include, but is not limited to, air, nitrogen, carbon dioxide, helium, or the like. Gas 60 between substrate 12 and template 18 may result in pattern distortion of features formed in patterned layer 46, low fidelity of features formed in patterned layer 46, non-uniform thickness of residual layer 48 across patterned layer 46, or the like.

In an imprint lithography process, gas trapped between the substrate and the template may escape through the polymerizable material, the substrate, or the template. The amount of gas that escapes through any medium may be influenced by the contact area between the trapped gas and the medium. The contact area between the trapped gas and the polymerizable material may be less than the contact area between the trapped gas and the substrate or the template. For example, a thickness of the polymerizable material on a substrate may be less than about 1 μm, or less than about 100 nm. In some cases, a polymerizable material may absorb enough gas to become saturated with the gas before imprinting, such that gas trapped during imprinting is substantially unable to enter the polymerizable material. In contrast, the contact area between the trapped gas and the substrate or the template may be relatively large.

The gas permeability of a medium may be expressed as P=D×S, in which P is the permeability, D is the diffusion coefficient, and S is the solubility. In a gas transport process, a gas adsorbs onto a surface of the medium, and a concentration gradient is established within the medium. The concentration gradient may serve as the driving force for diffusion of gas through the medium. Gas solubility and the diffusion coefficient may vary based on, for example, packing density of the medium. Adjusting a packing density of the medium may alter the diffusion coefficient and hence the permeability of the medium.

For a multi-layer film, effective permeability may be calculated from a resistance model, such as an analog of an electric circuit described by Peng et al., J. Membrane Sci. 222 (2003): 225-234 and A. Ranjit Prakash et al., Sensors and Actuators B 113 (2006): 398-409, both of which are incorporated by reference herein. The resistance of a material to the permeation of a vapor is defined as the permeance resistance, Rₚ. For a two-layer composite film with layer thicknesses l₁ and l₂, and corresponding permeabilities P₁ and P₂, permeance resistance may be defined as:

$${R}_{p} = \frac{Δ p}{J} = \frac{1}{( P / l ) A} \qquad ( 1 )$$

in which Δp is the pressure difference across the film, J is the flux, and A is the area. The resistance model predicts

Rₚ=R₁+R₂. (2)

When the cross-sectional area is the same for both materials 1 and 2, equation (2) may be rewritten as:

$$\frac{{l}_{1} + {l}_{2}}{P} = \frac{{l}_{1}}{{P}_{1}} + \frac{{l}_{2}}{{P}_{2}} \qquad ( 3 )$$

A gas may be thought of as having an associated kinetic diameter. The kinetic diameter provides an idea of the size of the gas atoms or molecules for gas transport properties. D. W. Breck, Zeolite Molecular Sieves—Structure, Chemistry, and Use, John Wiley & Sons, New York, 1974, p. 636, which is incorporated by reference herein, lists the kinetic diameter for helium (0.256 nm), argon (0.341 nm), oxygen (0.346 nm), nitrogen (0.364 nm), and other common gases.

In some imprint lithography processes, a helium purge is used to substantially replace air between the template and the substrate or imprinting stack with helium gas. To simplify the comparison between a helium environment and an air environment in an imprint lithography process, the polar interaction between oxygen in air and silica may be disregarded by modeling air as pure argon. Both helium and argon are inert gases, and argon has a kinetic diameter similar to that of oxygen. Unlike oxygen, however, helium and argon do not interact chemically with fused silica or quartz (e.g., in a template or substrate).

Internal cavities (solubility sites) and structural channels connecting the solubility sites allow a gas to permeate through a medium. The gas may be retained in the solubility sites. The size of the internal cavities and the channel diameter relative to the size (or kinetic diameter) of the gas influence the rate at which the gas permeates the medium.

The sizes of individual interstitial solubility sites of fused silica have been shown to follow a log-normal distribution by J. F. Shackelford, Gas solubility in glasses—principles and structural implications, J. Non-Cryst. Solids 253 (1999): 231-241, which is incorporated by reference herein. As indicated by the interstitial diameter distribution (mode=0.181 nm; mean=0.196 nm) and the kinetic diameter of helium and argon, the number of fused silica solubility sites available to helium exceeds the number of solubility sites available to argon. The total number of interstitial sites is estimated to be 2.2×10²⁸ per m³, with 2.3×10²⁷ helium solubility sites per m³ and 1.1×10²⁶ argon solubility sites per m³. The average distance between solubility sites for helium is considered to be 0.94 nm, while the average distance between solubility sites for argon is considered to be 2.6 nm. The structural channels connecting these solubility sites are thought to be similar to the helical arrangement of 6-member Si—O rings, with a diameter of about 0.3 nm. Table 1 summarizes some parameters affecting helium and argon permeability in fused silica.

TABLE 1
Selected properties of helium and argon.

| Property | Helium | Argon |
|---|---|---|
| Kinetic Diameter (nm) | 0.256 | 0.341 |
| Solubility Site Density (m⁻³) | 2.3 × 10²⁷ | 1.1 × 10²⁶ |
| Distance Between Solubility Sites (nm) | 0.94 | 2.6 |
| Structural Channel Diameter | ~0.3 | ~0.3 |
| Connecting Solubility Sites (nm) | | |

Boiko et al., Migration Paths of Helium in a-Quartz and Vitreous Silica from Molecular Dynamics Data, Glass Physics and Chemistry 29 (2003): 42-48, which is incorporated by reference herein, describes behavior of helium in amorphous or vitreous silica. Within a solubility site, the helium atom vibrates at an amplitude allowed by the interstitial volume. The atom passes from interstice to interstice through channels, which may be smaller in diameter than the interstices.

The parameters listed in Table 1 indicate that argon permeability in fused silica may be very low or negligible at room temperature (i.e., the kinetic diameter of argon exceeds the fused silica channel size). Since the kinetic diameters of oxygen and nitrogen are larger than the kinetic diameter of argon, air may be substantially unable to permeate fused silica. On the other hand, helium may diffuse into and permeate fused silica. Thus, when a helium environment is used rather than ambient air for a nano-imprint process, helium trapped between the template and the substrate may be able to permeate a fused silica template.

FIG. 4 is a side view of polymerizable material 34 between substrate 12 and template 400, along with an enlarged cross-sectional view of the template. The arrow indicates the direction of gas transport into template 400. A portion of template 400 includes a porous material with an ordered pore structure. The porous material may be in the form of an ordered porous layer. As used herein, a “porous” material refers to a material that is less dense than fused silica, more porous than fused silica, or both. Porous layers or films with an ordered pore structure may be thought of as having a non-random distribution of pores, for example, in the form of a repeating or periodic pore structure or a defined length scale between pores. The length scale may be as small as a few nanometers.

Template 400 includes ordered porous layer 402 between base layer 404 and cap layer 406. Ordered porous layer 402 has a substantially ordered or periodic pore structure. Ordered porous layer 402 may be formed, for example, by hydrothermal synthesis, vapor phase synthesis, sol-gel synthesis, anodization, or lithography on base layer 404. A thickness of ordered porous layer 402 may be at least about 10 nm. For example, a thickness of ordered porous layer 402 may be in a range of about 10 nm to about 100 μm, or in a range of about 100 nm to about 10 μm. In some cases, a thicker porous layer may provide higher effective permeability without significantly reducing performance related to, for example, UV transparency, thermal expansion, etc.

Ordered porous layer 402 may be made from materials including, but not limited to silica, alumina, titania, zirconia, organic polymers, and inorganic polymers. Adhesion of the ordered porous layer 402 to the base layer 404 and the cap layer 406 may be, for example, at least about three times the force required to separate the template from the patterned layer formed in an imprint lithography process. In some embodiments, the porous material may be substantially transparent to UV radiation. A Young's modulus of the porous material may be, for example, at least about 10 GPa, at least about 15 GPa, or at least about 20 GPa.

Pores 408 in ordered porous layer 402 may include pores of a defined shape and size, and may be interconnected with channels. Pores in porous layer 402 are larger than pores present in fused silica, and a porosity of porous layer 402 exceeds the porosity of fused silica. By varying process conditions and materials, ordered porous layers with different pore size, pore density (e.g., porosity or relative porosity), pore interconnectivity, pore wall thickness, and pore wall density may be produced. Permeability of template 400 may be adjusted by selecting a porosity and pore size of the porous layer 402. For example, increasing a thickness of the porous layer may yield a higher effective permeability than increasing the permeability of the porous layer.

As used herein, “porosity” refers to the fraction, as a percent of total volume, occupied by channels and open spaces in a solid. The porosity of ordered porous layer 402 may range from about 10% to about 65%, or from about 20% to about 55%. In some cases, the porosity of ordered porous layer 402 may be at least about 20% or at least about 30%. The relative porosity of similar materials may be defined as a relative difference in density of the materials. For example, a relative porosity of SOG (density ρ_{SOG}=1.4 g/cm³) with respect to fused silica (density ρ_{fused silica}=2.2 g/cm³) may be calculated as 100%×(ρ_{fused silica}−ρ_{SOG})/ρ_{fused silica}, or 36%. Fused silica is considered herein to be non-porous, and may be used as a reference material for other materials including oxygen-silicon bonds. In some embodiments, a relative porosity of a porous material including oxygen-silicon bonds with respect to fused silica is at least about 10%, at least about 20%, or at least about 30%.

Base layer 404 and cap layer 406 may be made of the same or different material. In some embodiments, base layer 404 may be fused silica and cap layer 406 may include SiOₓ, with 1=x=2.5, grown through a vapor deposition method. A thickness and composition of cap layer 406 may be chosen to provide mechanical strength and selected surface properties, as well as permeability to gases that may be trapped between a substrate or imprinting stack and a template in an imprint lithography process. In some embodiments, a thickness of cap layer 406 is less than about 100 nm, less than about 50 nm, or less than about 20 nm. In an example, cap layer 406 is about 10 nm thick. Cap layer 406 may be formed by material selected to achieve desirable wetting and release performance during an imprint lithography process. Cap layer 406 may also inhibit penetration of polymerizable material 34 into the ordered porous layer while allowing gas to diffuse through the cap layer and into the ordered porous layer 402. In some cases, cap layer 406 may be substantially flat, or unpatterned. In other cases, cap layer 406 may be patterned. As shown in FIG. 4, cap layer 406 has protrusions extending from cap layer 406.

In an example, template 400 is formed by depositing a 10 μm thick ordered porous layer (e.g., a zeolite) on a fused silica base layer, polishing the ordered porous layer and removing 5 μm of the layer, and growing a 100 nm thick cap layer of SiOₓ on top of the ordered porous layer. The cap layer is etched back to form protrusions 90 nm in height. As used herein, a thickness of cap layer 406 is considered independently of the height of the protrusions 410. Thus, the cap layer in this example is considered to be 10 nm thick, with protrusions 90 nm in height extending from the cap layer. At least about 50% of the template surface has a 10 nm thick covering of SiOₓ (i.e., about 50% of the template surface area is covered with protrusions) with a 5 μm thick ordered porous layer 402 underneath. Helium may diffuse more quickly through portions of the cap layer from which there are no protrusions, achieving an overall increase in helium permeability at least partially dependent on the thickness of the porous layer, the thickness of the cap layer, and the fraction of the surface area of the template free from protrusions.

In some cases, pores at a surface of a template (e.g., in a cap layer or other porous layer), if not sealed, may allow penetration of polymerizable fluid or other substances into the template, which may cause clogging of the pores or added stress during an imprinting process. If pores near a surface of a template are sufficiently small, sealing of the pores may not be needed to inhibit penetration of polymerizable fluid or other substances into the pores. In some cases, however, it is advantageous to seal or fill exposed pores (e.g., with a less porous silicon oxide layer) by using a thin film deposition method that produces substantially continuous, conformal, ultrathin gas-permeable films to inhibit disadvantageous penetration, clogging, saturation, and the like, of the template by polymerizable fluid or other substances. Pore sealing may be accomplished by a number of methods including, but not limited to, vapor-based film deposition processes such as chemical vapor deposition (CVD), atomic layer deposition (ALD), plasma-assisted atomic layer deposition (PA-ALD), pulsed plasma-enhanced chemical vapor deposition (pulsed-PECVD), molecular layer deposition (MLD), and physical vapor deposition (PVD), or by solution-based film deposition methods such as dip coating and spin coating, or plasma treatment. PA-ALD is described in US patent Application Publication No. US 2007/0190777, which is incorporated herein by reference. Pulsed-PECVD is described in U.S. Patent Application Publication No. 2008/0199632, which is incorporated herein by reference.

The selection of a seal layer deposition process and film composition can depend on several factors, including the size and/or geometry of template protrusions and recesses, the exposed pore diameter in the porous film, the desired permeability and mechanical properties of the seal layer, and the ability of the seal layer to interact with release agents, etc.

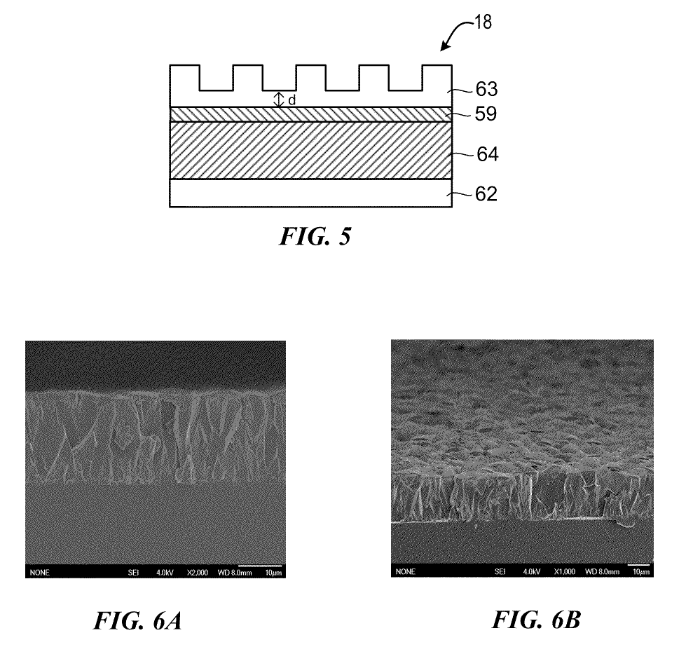

FIG. 5 shows a porous template 18 with a base layer 62, ordered porous layer 64, seal layer 59, and cap layer 63. Seal layer 59 may be made from materials including, but not limited to, metal oxides, nitrides, carbides, oxynitrides, oxycarbides, or polymers such as organo-silanes and polyxylylenes. A thickness of seal layer 59 on the surface of a porous layer may be less than about 10 nm (e.g., between about 1 nm and about 10 nm), less than about 5 nm, less than about 3 nm, or in some cases, less than about 5 times the pore radius, less than about 3 times the pore radius, or about two times the pore radius. In some cases, the pore sealing deposition method may be selected to substantially confine the reaction and growth of seal layer 59 to the surface of the porous layer. In certain cases, the seal layer reactants may be allowed to penetrate several nanometers into the porous layer.

Pore sizes in seal layer 59 may be larger than the kinetic diameter of the gas in the imprint environment to facilitate the diffusion of the gas into the adjoining porous layer. Pore sizes in seal layer 59 may be less than about 2 nm, less than about 0.8 nm, or less than about 0.6 nm, such that helium is able to diffuse through the seal layer. Seal layer 59 may be selected such that atoms or molecules larger than helium, oxygen, nitrogen, or carbon dioxide may be unable to diffuse through the seal layer. The seal layer preferably has pores large enough for helium to pass through, but small enough to substantially block reactive species in vapor or liquid phase from penetrating the porous layer during cap layer deposition. Seal layer 59 may include, for example, silicon oxide (SiOₓ). In some cases, rather than seal the surface pores completely with a continuous film, a seal layer process may be used to decrease the open pore size of the porous layer such that diameters of the pores inhibit the penetration (e.g., diffusion) of cap layer components into the porous layer.

The presence of the seal layer beneath the cap layer (e.g., between the cap layer and the porous layer) allows a clear transition from the cap layer to the porous layer, and inhibits penetration of pore-clogging contaminants into the porous layer. For example, seal layer 59 may inhibit penetration of reactive species present during formation of the cap layer 63 into porous layer 64. Penetration and pore clogging of the porous layer increases the density of the porous layer near the interface between the porous layer and, for example, the cap layer, and thus makes it difficult to ascertain the location of the interface during etching. The presence of a seal layer below the cap layer helps maintain the integrity of the interface, and reduce or substantially eliminate ambiguity as to the required etch depth of the features in the cap layer. Thus, the deposition of a seal layer on the porous layer enables the etch process, because it is advantageous to have as little cap layer material between the bottom of the feature and the porous layer underneath. This distance is indicated by d in FIG. 5.

In an example, an ordered porous layer is deposited on a base layer. A thin (e.g., 5 nm), dense pore seal layer, permeable to at least helium, is formed on the ordered porous layer, and a dense cap layer (95 nm) is formed on the seal layer. The total thickness of the dense coating is 100 nm. If the cap layer is etched to a depth of 90 nm, then d=10 nm, and 10 nm of dense film separates the bottom of the feature from the underlying ordered porous film. In the absence of a seal layer, then several nanometers of the ordered porous layer may have become blocked and the film density profile may vary with depth, all of which make it more difficult to determine how far to etch features in to the cap layer so that the features reside in a uniformly dense film with a known distance to the porous layer underneath. Some methods of pore sealing include ALD, PA-ALD, and pulsed PECVD, as well as other methods mentioned herein. Use of a method such as ALD to form the cap layer as well as the seal layer, however, would limit throughput and increase production costs.

Zeolites are crystalline microporous aluminosilicate materials with well-defined pore structures. Pore sizes may range from about 0.3 nm to about 2.0 nm. The crystalline structure includes tetrahedral atoms, or “T-atoms,” such as aluminum and silicon, which are tetrahedrally bonded to each other with oxygen bridges. In some cases, the structures include silicon (Si) and oxygen (O), but other T-atoms such as P, Sb, Ga, Ge, B, Be, and the like may exist in the structure. A zeolite membrane provides small pore size, high porosity, interconnected pores, thermal stability, and a mechanically strong crystalline framework. The porosity of zeolite materials may be expressed in terms of framework density, defined as the number of tetrahedral atoms per 1000 Å³. Lower framework density indicates higher microporosity. Framework density values range from about 12.5 to about 20.2.

In some embodiments, a zeolite membrane may be grown on non-porous template substrates such as synthetic fused silica or silicon, or on top of mesoporous or macroporous materials, such as anodic aluminum oxide, mesoporous silica, porous stainless steel, and the like, serving as an intermediate porous support layer between the zeolite membrane and a non-porous template material. In some embodiments, a porous inorganic layer may be infused with a zeolitic composition to create a composite structure. Polymer-zeolite composite films may also be formed as porous layers on a template.

Zeolite structures may be described as: i) channel-type zeolites, with linear channels that run in one direction; ii) intersecting channel-type zeolites (e.g. MFI-type zeolites), with channels that run in different directions and cross each other; and iii) three dimensional cage-type zeolites, with cage structures connected by small windows. MFI zeolites include, for example, silicalite-1 (aluminum free) and ZSM-5 (aluminum-containing). Pure silica MFI zeolite is a thermally and chemically stable inorganic microporous material. MFI zeolite membranes include intercrystalline pores of about 0.55 nm and intercrystalline gaps with openings of less than 2 nm. MFI zeolite has a microporosity of about 31% (i.e., a porosity of about 31%, with a pore size of less than about 2 nm in diameter (as described by Mitra et al., Synthesis and Evaluation of Pure-Silica-Zeolite BEA as Low Dielectric Constant Material for Microprocessors, Ind. Eng. Chem. Res. 43 (2004): 2946-2949, which is incorporated by reference herein), and a framework density of about 17.9.

Other types of zeolites may be synthesized with microporosities up to 50% (FAU zeolites). Pure-silica MFI zeolite films synthesized with an organic structure directing agent and subsequently calcined were reported to have an elastic modulus of 43 GPa and hardness of 4.3 GPa by M. C. Johnson et al., Effect of calcination and polycrystallinity on mechanical properties of nanoporous MFI zeolites, Materials Science and Engineering A 456 (2007): 58-63, which is incorporated by reference herein. These values are higher than those reported for non-ordered porous silica films of similar porosity. For example, PECVD silicon oxide film formed by plasma enhanced chemical vapor deposition with a relative porosity (vs. fused silica) of approximately 27% (density=1.6 g/cc) has a Young's modulus of 27 GPa (as decribed by Levy et al., A comparative study of plasma enhanced chemically vapor deposited Si—O—H and Si—N—C—H films using the environmentally benign precursor diethyl silane, Mater. Lett. 54 (2002): 102-107) and a hardness of <2 GPa. Only when the relative porosity of the PECVD SiOₓ film is decreased to approximately 14% (density=1.9 g/cm³) does the Young's modulus approach 40 GPa and hardness approach 5 GPa. Zeolite films described herein have a similar modulus and hardness of the PECVD SiOₓ film, but more than double the porosity. Thus, the zeolite films provide enhanced gas uptake and capacity compared to the non-ordered SiOx porous films.

Zeolite membranes may be formed on a nano-imprint lithography template or substrate, for example, by in-situ hydrothermal synthesis, secondary seeded growth synthesis, and dry gel conversion. In-situ synthesis is a one-step hydrothermal synthesis in which the substrate is placed in contact with a precursor solution. Secondary growth requires the attachment of zeolite seed crystals onto the substrate as nucleation sites, followed by hydrothermal growth of the seeds to form a continuous layer. Dry gel conversion includes vapor phase transport (VPT) and steam assisted crystalliztion (SAC). VPT refers to conversion of a dry, amorphous gel into a fully crystalline material via contact with a vapor including water and a volatile structure-directing agent (SDA) under autogeneous pressure. SAC refers to the conversion of a dry, amorphous gel including a non-volatile SDA into a fully crystalline material via contact with only vapor phase water under autogeneous pressure.

MFI zeolite membranes may be grown by in-situ crystallization by immersing a substrate in a synthesis solution including an organic silicate such as tetraethyl orthosilicate (TEOS) or tetramethyl orthosilicate (TMOS), tetrapropyl-ammonium hydroxide (TPAOH) and water, heating the system and maintaining autogeneous pressure in an autoclave, then drying and calcining the film as described U.S. Pat. No. 6,573,131, which is incorporated by reference herein. Zeolite films may be self-assembling. In some cases, an inorganic silica source such as fumed silica, colloidal silica, or silica gel may be used. A precursor solution including fumed silica, TPAOH, sodium hydroxide (NaOH), and deionized water and in-situ crystallization process are presented by J. Dong et al., Template-removal-associated microstructural development of porous-ceramic-supported MFI zeolite membranes, Microporous and Mesoporous Materials 34 (2000) 241-253 which is hereby incorporated by reference herein. An example of seeded secondary growth of an MFI-type zeolite membrane using a structure directing agent is presented by M. C. Johnson et al., Effect of calcination and polycrystallinity on mechanical properties of nanoporous MFI zeolites, Materials Science and Engineering A 456 (2007) 58-63, and methods for SDA-free synthesis of MFI zeolite membranes by conventional heating and microwave synthesis are taught by Z. Tang et al., Microwave synthesis of MFI-type zeolite embranes by seeded secondary growth without the use of organic structure directing agents, Microporous and Mesoporous Materials, 118(1-3) (2009) 224-231, all of which are incorporated by reference herein An example of vapor phase transport is presented by Thoma et al., Zeolite Synthesis by Vapor Phase Transport, Microporous and Mesoporous Materials, 2000, 41(1-3), 295, which is incorporated by reference herein.

Secondary growth synthesis provides a method to control nucleation site density, and may be used to overcome poor nucleation site density during in-situ crystallization. The process involves seed preparation, seed deposition, hydrothermal secondary growth, and organic template removal. Seeds may be prepared by a hydrothermal process. The nanoparticle seeds may be collected and re-dispersed in solution for coating. An optional binder, such as hydroxyl propyl cellulose, may be added to the suspension. The seed layer may be deposited by dip coating or spin-coating. Multiple coatings may be applied to increase surface coverage. After seeding, the layer may be dried and optionally calcined in air to remove the SDA from the seed crystals if template-free secondary growth follows. In some cases, calcination is optional. The seed layer may be annealed at temperatures up to 350° C. to promote bond formation between seed and substrate. In some cases, electrostatic deposition, electrophoretic deposition, and self-assembly by chemical cross-linkers may be used to help form a continuous layer of seed crystals.

A precursor solution for secondary growth may be prepared with an organic (SDA). Tetrapropylammonium hydroxide and tetrapropylammonium bromide are SDAs that may be used to synthesize MFI zeolite crystal structures. After membrane synthesis, the SDA may be removed by heating the film to temperatures greater than 400° C. In order to open the pores. Non-thermal methods, including UV-ozone and oxygen plasma methods, for removing organics from zeolite membranes are taught in U.S. Pat. Nos. 6,960,327 and 6,660,245, which are hereby incorporated herein by reference.

In some embodiments, a precursor solution for in-situ crystallization and secondary growth may be prepared without an organic SDA such that the high-temperature calcination step is not necessary. This approach is known as template-free synthesis. Template-free synthesis may be used to reduce defects and/or intercrystalline gaps that can form during the high temperature bake that is used to decompose and volatilize organics from the zeolite framework.

Crystal orientation in a polycrystalline zeolite film may range from random to oriented. Crystal orientation is described by E. E. McLeary et al., Zeolite based films, membranes and membrane reactors: Progress and prospects, Microporous and Mesoporous Materials 90 (2006): 198-220, which is incorporated by reference herein.

Another MFI zeolite membrane synthesis approach is to spin-on the as-synthesized zeolite nanoparticle suspension directly onto the substrate as described by U.S. Pat. No. 6,573,131, which is incorporated by reference herein. The resultant pore structure includes a bimodal distribution with micropores inherent to the zeolite crystal, and mesopores from interparticle spacing of the nanocrystals.

In an example, a template with a zeolite membrane may be fabricated as follows: a pure-silica MFI zeolite film is grown to a thickness of 2 μm on top of dense fused silica. After zeolite film growth, the surface of the film is polished smooth by CMP. A 100 nm thick layer of SiOₓ is then deposited on top of the zeolite film by chemical vapor deposition (CVD). The SiO₂ layer then goes through lithography and etch steps to pattern the SiOₓ layer to an etch depth of 90 nm. Therefore, in this example, 10 nm of SiO₂ remains between the etched-back SiO₂ surface and the zeolite membrane. In some cases, a template may be masked to inhibit growth of zeolite on some surfaces of the template. In certain cases, zeolite that forms on a surface of a template may be selectively removed.

In some cases, template-assisted mesoporous oxides may be used as porous layers with an ordered pore structure in a nano-imprint lithography template. The resulting layers are mesoporous with a highly ordered long-range structure that is amorphous at the atomic level. In some embodiments, an ordered mesoporous structure may be used in place of another porous material (e.g., a zeolite) or to support a porous film (e.g., a zeolite film) when layers with different pore sizes are desired in the template construction. In this case, the mesoporous oxides may provide larger pore sizes than the zeolites. Pore sizes in mesoporous oxides may be controlled to range, for example, from about 2 nm in diameter to about 50 nm in diameter.

Self-assembling amphiphilic materials used as templates to create the ordered mesoporous structure may include surfactants and block co-polymers. The use of different templates like block copolymers (e.g., PEO-PPO-PEO, PEO-PBO-PEO), and methyl ammonium compounds (e.g., cetyltrimethyl ammonium bromide (CTAB) and cetyltrimethylammonium chloride (CTAC)) give rise to different mesoporous structures (e.g., 2-D hexagonal, 3-D hexagonal, cubic, and lamellar). The template-assisted synthesis route allows the porosity, pore size, and pore shape to be controlled using the properties of the surfactants and block copolymers and their interactions with the inorganic species. By comparison, for disordered mesoporous oxides, the pore structure may be determined by the amount of precursor branching or aggregation (e.g., xerogels), or by the incorporation of sacrificial organic porogens in the sol that are later removed by thermolysis or plasma processing. For a given level of porosity, the control afforded by self-assembled templates may result in improved mechanical properties compared with non-ordered films of similar porosity and composition. Silica, alumina, and titania are examples of inorganic oxides that may be used to form a porous layer of a template by self-assembling materials. Examples of mesoporous silicas synthesized by the self-assembled template approach include MCM-41 (hexagonal phase), MCM-48 (cubic phase), and MCM-50 (lamellar phase).

Sol-gel synthesis and vapor phase synthesis may be used to fabricate ordered mesoporous oxides. The sol is a liquid solution including a soluble precursor of an inorganic material dissolved in a suitable solvent. Alkoxides, a family of sol-gel precursors, include metal atoms linked to organic ligands via oxygen bridges, such as tetraethoxysilane (TEOS), a precursor of silica (SiO₂).

Mechanical properties of template-assisted mesoporous oxides may vary based on porosity and synthesis method. U.S. Pat. No. 6,239,017, which is incorporated by reference herein, describes a template-assisted mesoporous silica film with 55% porosity having an elastic modulus of 14-17 GPa as measured by nano-indentation. By comparison, the modulus of sol-gel films may be less than 6 GPa.

Ordered mesoporous oxide layers may be formed on a nano-imprint lithography template by methods including dip coating and spin coating. An example of spin coating a silica precursor solution onto a 4″ wafer and forming an ordered mesoporous silica film by using a surfactant template is disclosed in U.S. Pat. No. 6,239,017, which is incorporated by reference herein. A similar approach may be used to fabricate a nano-imprint lithography template or substrate with a porous layer including mesoporous silica. After forming the mesoporous silica film on the nano-imprint lithography template, the silica surface may be polished to achieve a certain roughness and flatness. A cap layer may be deposited on the ordered mesoporous layer. In some cases, a seal layer is deposited on the porous layer, and a cap layer is deposited on the porous layer. The cap layer may include a material, such as SiO₂ or SiC, suitable for lithography and patterning.

In an example, 100 nm of dense SiO₂ is deposited by CVD on top of an ordered mesoporous layer. The dense SiO₂ may then go through lithography and etch steps to define the pattern in the template. If the features are etched 90 nm deep, then 10 nm of CVD SiO₂ may reside on top of the mesoporous layer in the etched-back surfaces.

Surfaces formed during the formation of a porous layer of a nano-imprint lithography template substrate may be undesirably rough. The roughness reduces the usefulness and desirability of these surfaces for use as an imprint surface for patterning, or for use as a base layer for the deposition of a conformal film. In some cases, chemical mechanical planarization (CMP) can be used to polish a rough layer to substantially eliminate the roughness and improve flatness and parallelism of the template. CMP may also improve filling speed by reducing a roughness of a layer that contacts the imprint resist. CMP includes the polishing of one or both sides of a substrate simultaneously, using both chemical and mechanical means. In an example, an imprint lithography template is held in a carrier housing. Slurry is dispensed on a polishing pad. The template is rotated and oscillated (eccentric motion) and is brought into contact with a rotating polishing pad. The force of the substrate against the pad is controlled. The slurry both reacts with the surface (chemical aspect of CMP) and physically scrubs the surface (mechanical aspect of CMP). The abraded material is carried away by the polishing pad.

### Examples

A one-step hydrothermal synthesis process was used to grow MFI-type zeolite on a non-porous fused silica substrate. A synthesis solution of tetrapropyl ammonium hydroxide (40%, aqueous, available from SACHEM, Austin Tex.), tetrapropyl ammonium bromide (98%, crystals available from SACHEM, Austin Tex.), de-ionized water (18 MO, generated via Millipore Simplicity 185), and Snowtex ST-S (Colloidal SiO2, available from Nissan Chemical America Corporation, Houston Tex.) were mixed in the molar ratios shown in Table 2. The Snowtex ST-S, TPAOH, TPABr, and de-ionized water were mixed in this order in a PFA beaker under continuous stirring. The beaker was covered and stirred on a hotplate for 6 hours at a temperature of 50° C.

TABLE 2

| TPAOH | TPABr | DI Water | SiO₂ |
|---|---|---|---|
| (molar %) | (molar %) | (molar %) | (molar %) |
| 0.70 | 0.97 | 92.77 | 5.56 |

Thirteen grams of the synthesis solution were added to a 45 mL acid digestion bomb (available from Parr Instrument Company, Moline Ill.). A fused silica sample measuring approximately 1 mm in thickness and 2 cm² in area was placed at a 45 degree angle in the solution. The reactor was sealed and placed in a Yamato gravity convection oven pre-heated to 160° C. (model DVS402, available from Yamato Scientific America, Santa Clara, Calif.). The oven was turned off after 12 hours and the reactor was allowed to cool to room temperature. The sample was heated to a temperature of 490° C. at a rate of 3° C./min and held at that temperature for 4 hours, and then cooled down at a rate of 3° C./min using temperature controller (model 270, available from J-KEM Scientific, St. Louis, Mo.) and a home-made furnace. A thick, dense zeolite film was obtained on the fused silica substrate. The film thickness of the downward facing surface in the reactor measured 19 um by scanning electron microscope (SEM). FIG. 6A is an SEM image showing a cross-section of the zeolite film, and FIG. 6B shows a tilt view of the surface.

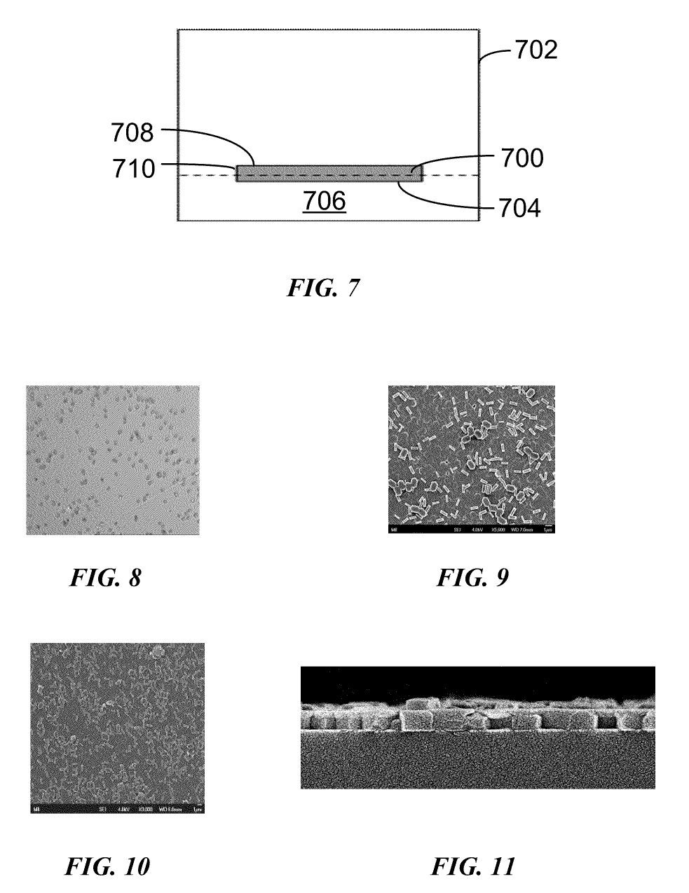

FIG. 7 illustrates a nano-imprint lithography template 700 in an autoclave 702. Imprint side 704 of the template 700 to be coated with a zeolite film is positioned in the synthesis solution 706 (below dotted line). The template 700 can be held in this position by a mechanical fixture such that the solution 706 does not contact backside 708 of the template. This arrangement promotes growth of zeolite on imprint side 704 of the template, while allowing the backside 708 to remain substantially pristine (e.g., in a polished state) to serve as a reference flat for polishing the imprint side 704. Sides 710 of the template will grow zeolite in this arrangement, however the sides and edges can be diced and polished. The imprint side 704 will undergo polishing. The template 700 does not have to be position horizontally in the autoclave. In some cases, for instance, the template can be placed at any angle from horizontal to vertical. Positioning the side of interest (e.g., the imprint side) downward may inhibit contamination of the this side with fall-on particles are minimized. More than one template can be placed in an autoclave at the same time.

In some cases, an etch stop layer can be deposited on the surfaces of the template so that after zeolite growth, the zeolite can be removed by etching down to the stop layer. The etch stop layer,has different etch selectivey than the zeolite, preferably greater than 10:1. If the zeolite is made mostly of silicon and oxygen, then a suitable etch stop layer may include Cr or SiₓN_{y}. The sides and backside of a template may be coated with an etch stop layer, and the imprint side left uncoated. After zeolite growth, the zeolite layer on the imprint side may be masked, for example by deposting a thin Cr film by CVD and then spin coating a layer of photoresist on top to protect it from the reactive species used to remove the zeolite. After zeolite removal from the non-preferred surfaces, it may be desirable to remove the etch stop layer if it reduces UV light transmission through the template by etching or polishing. For example, a chrome stripping chemistry can be used to remove a chrome etch stop layer without etching a fused silica base layer. After removing zeolite from non-preferred surfaces or after removing the etch stop layer, the protective etch mask can be removed from the imprint surface for the next step, such as polishing.

A dense, continuous zeolite layer may be grown on the surface of a template. In one experiment, tetraproylammonium hydroxide (TPAOH, 40%, SACHEM), deionized water, and tetraethylortosilicate (TEOS; >98%, Sigma Aldrich) were mixed and stirred for 2 hours on a hotplate at 50° C. The molar composition of the resulting synthesis solution was 0.32 TPAOH:1 TEOS:165 H₂O. The solution was transferred into a 1 L 316 ss pressure vessel with a PTFE liner (available from Parr Instrument Co.). Fused silica substrates were place inside and immersed the synthesis solution. Some of the fused silica substrates were coated with 15 nm of chrome oxide on one surface. The orientation of the fused silica and CrO coated surfaces were varied so that some of the growth surfaces were facing up and some were facing down at slight angles. The vessel was sealed and placed in an oven pre-heated to 165° C. The oven was turned off after 6 hours. As seen in FIG. 8, an SEM image of the substrate showed scattered seed crystals but no zeolite film growth on the fused silica surfaces. A continous layer of b-oriented crystals approximately 450 nm thick was formed on the CrO film, as seen in FIG. 9.

A film was grown under similar conditions on a stainless steel substrate after 6 hours at 165° C., as shown in FIG. 10. The hydrothermal synthesis time was reduced to 2 hours and, using the above synthesis solution, a zeolite layer formed on a CrO surface as shown in FIG. 11.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A nano-imprint lithography template comprising:
a non-porous base layer;
a cap layer; and
a porous layer between the base layer and the cap layer, the porous layer defining a multiplicity of pores and having an ordered pore structure,
wherein the cap layer is permeable to helium, and the pores in the porous layer are configured to accept gas passing through the cap layer during an imprint lithography process.

2. The nano-imprint lithography template of claim 1, further comprising a pore seal layer between the porous layer and the cap layer.

3. The nano-imprint lithography template of claim 1, wherein the cap layer is configured to be etched by an imprint lithography process.

4. The nano-imprint lithography template of claim 1, wherein the cap layer is patterned, and the pattern comprises a multiplicity of protrusions.

5. The nano-imprint lithography template of claim 1, wherein the base layer comprises fused silica.

6. The nano-imprint lithography template of claim 1, wherein the pores are connected by channels.

7. The nano-imprint lithography template of claim 1, wherein the porous material comprises a zeolite.

8. The nano-imprint lithography template of claim 7, wherein the porous material is a zeolite.

9. The nano-imprint lithography template of claim 8, wherein the zeolite is selected from the group consisting of channel-type zeolites, intersecting channel-type zeolites, and three-dimensional cage-type zeolites.

10. The nano-imprint lithography template of claim 9, wherein the zeolite is an MFI-type zeolite.

11. The nano-imprint lithography template of claim 10, wherein the zeolite is a pure silica zeolite.

12. The nano-imprint lithography template of claim 1, wherein the porous material comprises a template-assisted mesoporous oxide.

13. The nano-imprint lithography template of claim 1, wherein a Young's modulus of the porous layer is at least about 20 GPa.

14. The nano-imprint lithography template of claim 1, wherein a hardness of the porous layer is at least about 3 GPa.

15. The nano-imprint lithography template of claim 1, wherein a porosity of the porous layer is at least about 20%.

16. A nano-imprint lithography method, comprising:
dispensing a polymerizable composition onto a surface of a nano-imprint lithography substrate;
contacting the polymerizable material with a patterned nano-imprint lithography template, wherein the template comprises a porous layer defining a multiplicity of pores with an ordered pore structure;
solidifying the polymerizable material to form a solidified layer adhered to the nano-imprint lithography substrate; and
separating the template from the solidified patterned layer.

17. The method of claim 16, wherein the porous layer of the nano-imprint lithography template comprises a zeolite.

18. The method of claim 16, wherein dispensing the polymerizable composition comprises dispensing a multiplicity of drops of the polymerizable composition onto the surface of the nano-imprint lithography substrate.

19. A method of making a nano-imprint lithography template, the method comprising:
forming a porous layer defining a multiplicity of pores with an ordered pore structure on a non-porous substrate;
forming one or more additional layers on the porous layer of the nano-imprint lithography template; and
etching one of the additional layers to form a patterned imprint lithography template.

20. The method of claim 19, wherein forming the porous layer comprises growing a zeolite film on the non-porous substrate in an autoclave at autogenous pressure.
